(19) United States
(12) Patent Application Publication
(10) Pub. No.: US 2023/0029058 A1
(43) Pub. Date: Jan. 26, 2023

(54) COMPUTING SYSTEM FOR NEWS AGGREGATION

(71) Applicant: Microsoft Technology Licensing, LLC, Redmond, WA (US)

(72) Inventors: Abebe Tadesse BIRU, Issaquah, WA (US); Mansi VERMA, Kirkland, WA (US); Brandon James LOUDEN, Everett, WA (US)

(21) Appl. No.: 17/385,639

(22) Filed: Jul. 26, 2021

(51) Int. Cl. G06F 16/9535; G06F 16/9538; G06F 40/30; G06F 16/906; G06K 9/62

(52) U.S. Cl. CPC G06F 16/9535; G06F 16/9538; G06F 40/30; G06F 16/906; G06K 9/6215

(57) ABSTRACT

A computing system obtains titles and abstracts of a plurality of news articles. The computing system generates an encoded, vectorized representation of each of the plurality of news articles based upon the titles and the abstracts. The computing system computes a similarity metric between each of the plurality of news articles based upon the encoded, vectorized representation of each of the plurality of news articles. The computing system clusters the plurality of news articles into a plurality of clusters based upon the similarity metric computed between each of the plurality of news articles, where each cluster in the plurality of clusters corresponds to a different topic. For each cluster in the plurality of clusters, the computing system causes a respective title and a respective abstract of a representative news article to be displayed on a display.

### BACKGROUND

A news aggregator is a computer-executable application that aggregates news articles from various electronic sources (e.g., different websites) and that presents information (e.g., titles and abstracts) pertaining to the news articles in one location on a display of a computing device. When a title or an abstract of a news article shown on the display is selected by a user, the computing device retrieves the (full) news article from its respective source and presents the (full) news article on the display. However, many different news articles pertaining to the same topic may exist. In an example, a first website and a second website respectively publish a first news article and a second news article about the same event. A conventional news aggregator may display information from both the first news article and the second news article to the user, despite the two news articles including content that is topically similar (which is an inefficient use of limited display screen real estate).

Conventional technologies for identifying duplicative news articles tend to be based upon lexical similarity between news articles and are constrained by a lexicon. As such, conventional technologies may fail to correctly identify a first news article and a second news article as duplicative when the second news article is a rewritten version of the first news article. Furthermore, conventional technologies tend to be language-specific and require different models to account for different languages.

### SUMMARY

The following is a brief summary of subject matter that is described in greater detail herein. This summary is not intended to be limiting as to the scope of the claims.

Described herein are various technologies pertaining to aggregation of news articles. In an example, a computing system generates encoded vectors based upon content of a plurality of news articles, where each encoded vector represents a different news article. The computing system computes a similarity metric between each of the plurality of news articles based upon each encoded vector and clusters the plurality of news articles into a plurality of clusters based upon the computed similarity metric, where each cluster pertains to a different topic and where each news article within a cluster pertains to the same topic. The computing system selects a representative news article for each cluster (and hence each topic) and presents information (e.g., a title and an abstract) for the representative news article on a display.

In another example, a computing system obtains titles and abstracts of a plurality of news articles from a plurality of electronic sources. The computing system generates an encoded, vectorized representation (e.g., an n-dimensional vector, where n is a positive integer) of each of the plurality of news articles based upon the titles and the abstracts. The computing system computes a similarity metric (e.g., a value) between each of the plurality of news articles based upon the encoded, vectorized representation of each of the plurality of news articles. A similarity metric between a first news article and a second news article is indicative of semantic similarity between the first news article and the second news article. According to embodiments, the similarity metric is cosine similarity.

The computing system clusters the plurality of news articles into a plurality of clusters based upon the similarity metric computed between each of the plurality of news articles, where a number of clusters is determined dynamically based upon the similarity metric computed between each of the plurality of news articles. According to embodiments, the computing system utilizes a density-based clustering model to cluster the plurality of news articles. Each cluster in the plurality of clusters corresponds to a different topic and includes at least two news articles. The computing system is also configured to identify certain news articles in the plurality of news articles as orphans. An orphan news article is a single news article written about a unique topic, that is, the orphan news article is the only news article in the plurality of news articles written about the unique topic. News articles in a cluster pertain to the same topic (e.g., the news articles in the cluster are duplicative to one another). According to embodiments, the computing system ranks each news article within each cluster based upon ranking criteria. The computing system selects a representative news article from each of the clusters and causes a title and an abstract of each representative news article to be presented on a display.

The above-described technologies present various advantages over conventional technologies for identifying duplicative news article during news aggregation. First, unlike conventional technologies which identify duplicative articles based upon lexical similarity, the above-described technologies identify duplicative news articles based upon semantic similarity. As such, the above-described technologies are able to better identify duplicative news articles, even when the duplicative news articles are not exact copies of one another. Second, vis-à-vis the combination of steps described above, the above-described technologies are language agnostic and can cluster news articles written in any language provided that the encoder is also language agnostic. Third, unlike conventional technologies, the above-described technologies are not limited to a pre-defined number of clusters, rather, the above-described technologies dynamically determine a number of clusters based upon content of news articles. Fourth, by identifying duplicative news articles and displaying a representative news article for a topic (as opposed to several duplicative news articles pertaining to the same topic), the above-described technologies preserve limited display space of computing devices and also reduce user input required to view different news articles.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an example computing system that facilitates news aggregation.

FIGS. 2A-F depict an example high-level overview of operation of the computing system in FIG. 1.

FIG. 3 is an example graphical user interface (GUI) of a news application.

FIG. 4 is a flow diagram that illustrates an example methodology executed by a computing system for clustering and delivering news articles to computing devices for display.

FIG. 5 is a flow diagram that illustrates an example methodology executed by a client computing device for displaying information pertaining to aggregated news articles.

FIG. 6 is an example computing device.

Various technologies pertaining to news aggregation are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

### DETAILED DESCRIPTION

As noted above, conventional news aggregation technologies identify duplicative news articles (e.g., scraped news articles, rewritten news articles, or republished news articles) based upon lexical similarity using a lexicon. As such, conventional news aggregation technologies fail to identify duplicative news articles. To address these issues with conventional technologies, a computing system is described herein that is configured to cluster news articles into clusters representing different topics based upon semantic similarity between the news articles, where a quantity of the clusters is determined dynamically based upon content of the news articles and where the computing system does not utilize a lexicon to perform the clustering (e.g., the computing system does not rely solely upon lexical similarity to perform the clustering). The computing system is further configured to present information pertaining to representative news articles for each topic on a display.

In an example, a computing system obtains titles and abstracts of a plurality of news articles from a plurality of electronic sources. According to embodiments, the plurality of news articles relate to eSports news. The computing system generates an encoded, vectorized representation (e.g., an n-dimensional vector) of each of the plurality of news articles based upon the titles and the abstracts. According to embodiments, the computing system utilizes a transformer-based encoder to generate the encoded, vectorized representation of each of the plurality of news articles. The computing system computes a similarity metric (e.g., a value) between each of the plurality of news articles based upon the encoded, vectorized representation of each of the plurality of news articles. A similarity metric between a first news article and a second news article is indicative of semantic similarity between the first news article and the second news article. According to embodiments, the similarity metric is cosine similarity.

The computing system clusters the plurality of news articles into a plurality of clusters based upon the similarity metric computed between each of the plurality of news articles, where the number of clusters is determined dynamically based upon the similarity metric computed between each of the plurality of news articles. According to embodiments, the computing system utilizes a density-based clustering model to cluster the plurality of news articles. Each cluster in the plurality of clusters corresponds to a different topic and includes at least two news articles. As such, news articles in a cluster pertain to the same topic (e.g., the news articles in the cluster are duplicative to one another). According to embodiments, the computing system clusters the plurality of news articles according to factors such as dates of publication of the plurality of news articles or geographic regions to which the plurality of news articles pertain. The computing system is also configured to identify certain news articles in the plurality of news articles as orphans. An orphan news article is a single news article written about a unique topic, that is, the orphan news article is the only news article in the plurality of news articles written about the unique topic. According to embodiments, the computing system ranks each news article within each cluster based upon ranking criteria, such as a number of times each news article has been viewed or dates of publication of each news article. The computing system selects a representative news article from each of the clusters. Upon receiving a request for news, the computing system causes a title and an abstract of each representative news article to be presented on a display of a computing device. The computing system may also cause titles and abstracts of orphan news articles to be presented on the display of the computing device. When an abstract and/or a title of a representative news article (or an orphan news article) is selected, the computing device displays the (full) news article.

The above-described technologies present various advantages over conventional technologies for identifying duplicative news article during news aggregation. First, unlike conventional technologies which identify duplicative articles based upon lexical similarity, the above-described technologies identify duplicative news articles based upon semantic similarity. As such, the above-described technologies are able to better identify duplicative news articles, even when the duplicative news articles are not exact copies of one another. Furthermore, the above-described technologies are not constrained by a lexicon. Second, vis-à-vis the combination of steps described above, the above-described technologies are language agnostic and can cluster news articles written in any language. Third, unlike conventional technologies, the above-described technologies are not limited to a pre-defined number of clusters, rather, the above-described technologies dynamically determine a number of clusters based upon content of news articles. Fourth, by identifying duplicative news articles and displaying a representative news article for a topic (as opposed to several duplicative news articles pertaining to the same topic), the above-described technologies preserve limited display space of computing devices and also reduce user input required to view different news articles.

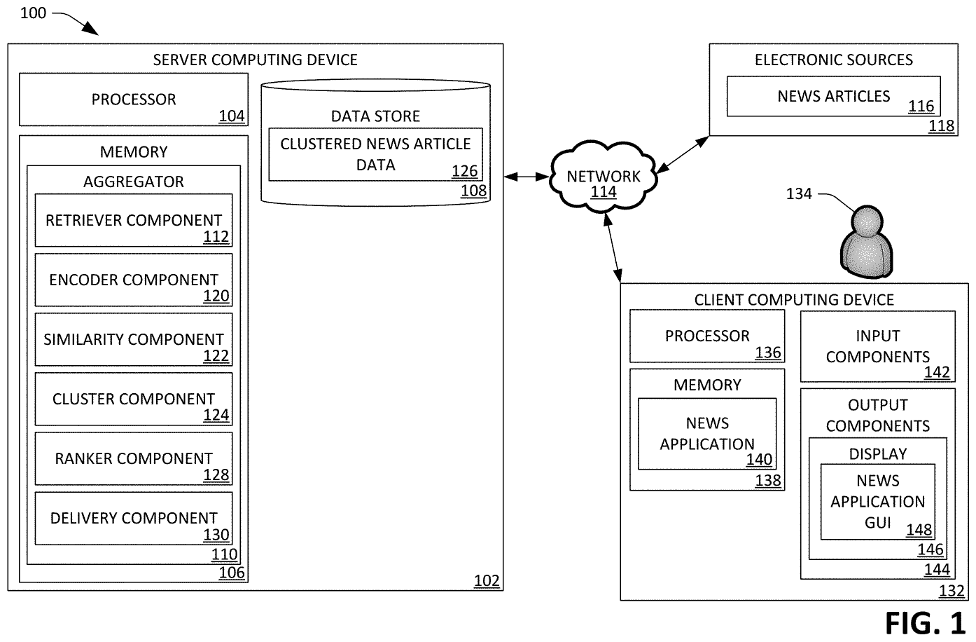

With reference to FIG. 1, an example computing system 100 that facilitates news aggregation is illustrated. The computing system 100 includes a server computing device 102. According to embodiments, the server computing device 102 is a cloud-based computing platform. The server computing device 102 includes a processor 104, memory 106, and a data store 108. The memory 106 has an aggregator application 110 (also referred to herein as “the aggregator 110”) loaded therein. The aggregator 110, when executed by the processor 104, is generally configured to cluster computer-readable news articles into different clusters, where news articles belonging to a cluster each relate to the same topic. In an example, the topic is a Sports Team X winning a championship game, and each news article belonging to a cluster relates to Sports Team X winning the championship game.

The aggregator 110 includes a retriever component 112. The retriever component 112 is configured to obtain (e.g., retrieve), over a network 114 (e.g., the Internet, intranet, etc.) a plurality of (computer-readable) news articles 116 (or portions of the plurality of news articles 116) from a plurality of electronic sources 118. It is to be understood that the plurality of news articles 116 may be written in different languages (e.g., English, Spanish, etc.). It is also to be understood that some of the plurality of news articles 116 are duplicative to one another. Duplicative news articles include scraped news articles, rewritten news articles, or republished news articles. An example news article in the plurality of news articles 116 includes a title, an abstract, content, an identifier for a publisher of the news article, and a uniform resource locator (URL) of the news article. According to embodiments, the retriever component 112 obtains titles and abstracts of the plurality of news articles 116 (without obtaining the full news articles themselves). According to embodiments, the plurality of electronic sources 118 comprise websites, such as news websites. According to embodiments, the retriever component 112 obtains news articles at a predefined interval of times (e.g., once every thirty minutes, once every hour, once every day, etc.). According to embodiments, the retriever component 112 obtains the plurality of news articles 116 (or a portion of information contained within the plurality of news articles 116, such as titles and abstracts) from a computer-implemented service (not shown in FIG. 1) that obtains the plurality of news articles 116 from the plurality of electronic sources 118. According to embodiments, the plurality of news articles 116 relate to eSports news.

The aggregator 110 further includes an encoder component 120. The encoder component 120 is configured to generate an encoded, vectorized representation of each of the plurality of news articles 116. In an example, the encoder 120 generates an n-dimensional vector for each of the plurality of news articles 116 based upon respective titles and (text of) abstracts of each of the plurality of news articles 116, where n is a positive integer greater than one and where each n-dimensional vector represents a different news article in the plurality of news articles 116. In an example, n ranges from 10-1000. Each entry in the n-dimensional vector includes a value. The n-dimension vector is an embedded representation of the title and the abstract. According to embodiments, the encoder component 120 is or includes a transformer-based encoder. According to other embodiments, the encoder component 120 is or includes a neural network-based encoder. According to some embodiments, the encoder component 120 includes a language agnostic encoder.

The aggregator 110 also includes a similarity component 122. The similarity component 122 is configured to generate a similarity metric (e.g., a value) between each of the plurality of news articles 116 based upon the encoded, vectorized representation of each of the plurality of news articles 116. In general, a similarity metric between a first news article and a second news article is indicative of a likelihood that the first news article and the second news article relate to the same topic. The similarity metric between each of the plurality of news articles 116 is indicative of semantic (as opposed to lexical) similarity between each of the plurality of news articles 116. According to embodiments, the similarity metric ranges from 0.0 to 1.0, where 0.0 indicates that the first news article and the second news article are unlikely to relate to the same topic and where 1.0 indicates that the first news article and the second news article likely relate to the same topic (or are identical to one another). According to embodiments, the similarity metric is cosine similarity.

According to embodiments, the similarity component 122 organizes each computed similarity metric into a m×m matrix, where m is the number of news articles 116 obtained by the retriever component 112. Each news article is assigned a row and a column in the matrix. In an example, the plurality of news articles 116 include a first news article, a second news article, and a third news article. In the example, a first row and a first column of the matrix are assigned to the first news article, a second row and a second column of the matrix are assigned to the second news article, and a third row and a third column of the matrix are assigned to the third news article. In an example, an entry in the matrix at the first row and the third column includes a similarity metric computed between the first news article and the third news article and that is indicative of semantic similarity between the first news article and the third news article. In another example, an entry in the matrix at the second row and the first column includes a similarity metric computed between the second news article and the first news article and that is indicative of semantic similarity between the second news article and the first news article.

The aggregator 110 further includes a cluster component 124. The cluster component 124 is configured to cluster the plurality of news articles 116 into a plurality of clusters based upon each similarity metric computed by the similarity component 122, where each cluster is assigned to a different topic represented in the plurality of news articles 116. The cluster component 124 is also configured to identify an “orphan” news article that is a single news article written on a unique topic, that is, there are no other news articles in the plurality of news articles 116 written on the unique topic. Each news article belonging to a cluster pertains to the same topic. According to embodiments, the cluster component 124 determines a number of clusters based on each similarity metric computed by the similarity component 122 (as opposed to having a predefined number of clusters). According to embodiments, the cluster component 124 is or includes a density-based clustering model, such as density-based spatial clustering of applications with noise (DBSCAN). A density-based clustering model connects data points that satisfy a density criterion. A density-based clustering model identifies clusters in data (e.g., clusters of news articles) based upon a cluster in a data space being a contiguous region of high point density, separated from other such clusters by contiguous regions of low point density. According to embodiments, the cluster component 124 clusters the plurality of news articles 116 according to factors such as dates of publication of the plurality of news articles or geographic regions to which the plurality news articles 116 pertain.

The cluster component 124 is further configured to store clustered news article data 126 for the plurality of news articles 116 in the data store 108 subsequent to the plurality of news articles 116 being clustered into the plurality of clusters. The clustered news articles data 126 is organized into a plurality of clusters, where each cluster corresponds to a different topic and where each cluster includes information from at least one news article from the plurality of news articles 116. For a given news article, the cluster news article data 126 includes a title of the news article, an abstract of the news article, a uniform resource locator (URL) of the news article, and a provider (e.g., the publisher of) the news article. According to embodiments, the clustered news article data 126 is stored in JavaScript Object Notation (JSON) format or Extensible Markup Language (XML) format or other similar structured data format.

According to embodiments, the aggregator 110 further includes a ranker component 128. The ranker component 128 is configured to assign ranks to news articles within each cluster in the plurality of clusters based upon ranking criteria. The ranking criteria may include a date a news article was published, a number of times the news article has been accessed, a number of references in the news article to other news articles, a number of references in other news articles to the news article, a number of times the news article has been shared between different users, a length of the news article, a language in which the news article is written, user data of a user, manually set forth factors, etc. The ranker component 128 is also configured to select a representative news article from each of the plurality of clusters (and hence each topic) based upon the ranks.

The aggregator 110 further includes a delivery component 130. The delivery component 130 is configured to information (e.g., a title and an abstract) from a representative news article (identified by the ranker component 128) from each of the plurality of plurality of clusters (and hence each topic) to a plurality of computing devices operated by users.

The computing system 100 further includes a client computing device 132 that is operated by a user 134. The client computing device 132 is in communication with the server computing device 102 by way of the network 114. According to embodiments, the client computing device 132 is a desktop computing device, a laptop computing device, a tablet computing device, a smartphone, a wearable computing device, or a gaming console.

The client computing device 132 includes a processor 136 and memory 138, where the memory 138 has a news application 140 loaded therein. The news application 140, when executed by the processor 136, is generally configured to present, to the user 134, a title and an abstract of a representative news article from each of the plurality of clusters (and hence each topic) identified by the aggregator 110. The news application 140 may also present orphan news articles to the user 134. According to embodiments, the news application 140 is a web-based application that executes within a web browser. According to embodiments, the news application 140 is Microsoft® Bing, MSN®, or a landing page of the Microsoft® XBOX® gaming console. According to embodiments, the news application 140 is integrated into an operating system loaded in the memory 138 of the client computing device 132.

The client computing device 132 further includes input components 142 that enable the user 134 to set forth input to the client computing device 132. The input components 142 may include a mouse, a keyboard, a trackpad, a scroll wheel, a touchscreen, a camera, a video camera, a controller, etc. The client computing device 132 also includes output components 144 that enable the computing device 132 to output information for presentment to the user 134. The output components 144 include a display 146. The news application 140 presents a graphical user interface (GUI) 148 for the news application 140 (also referred to herein as “the news application GUI 148”) on the display 146.

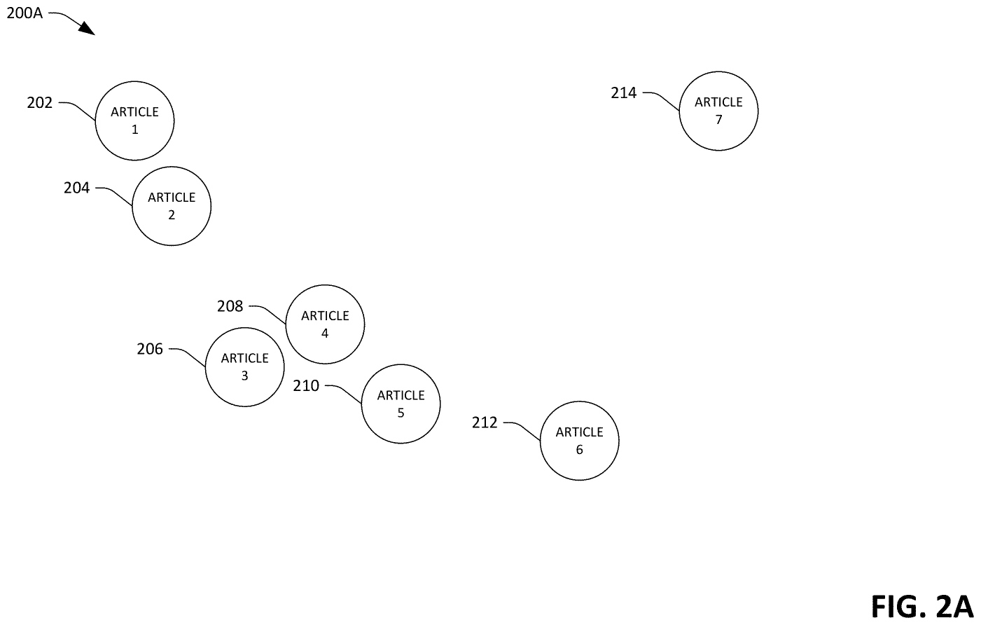

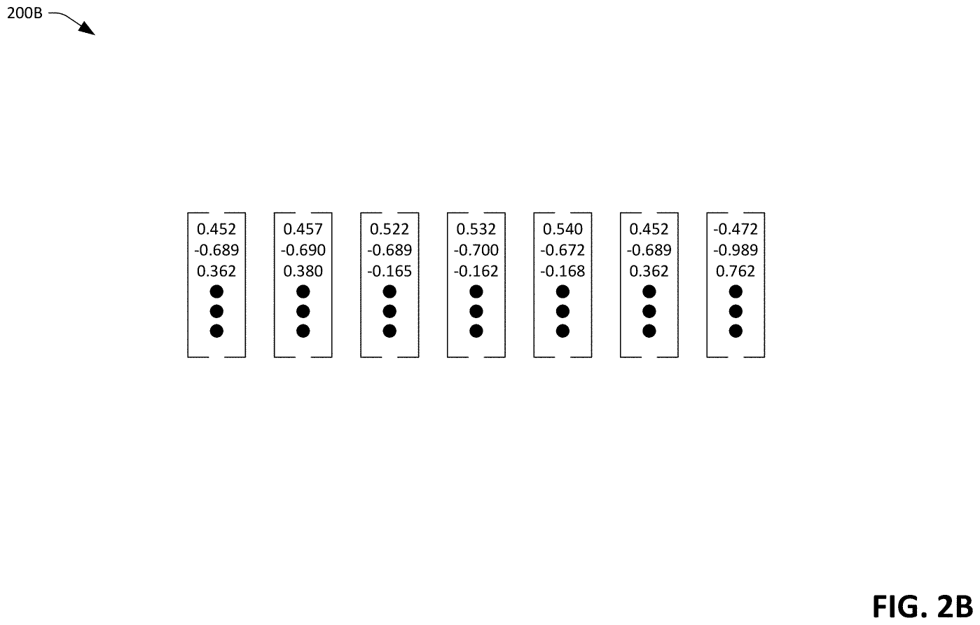

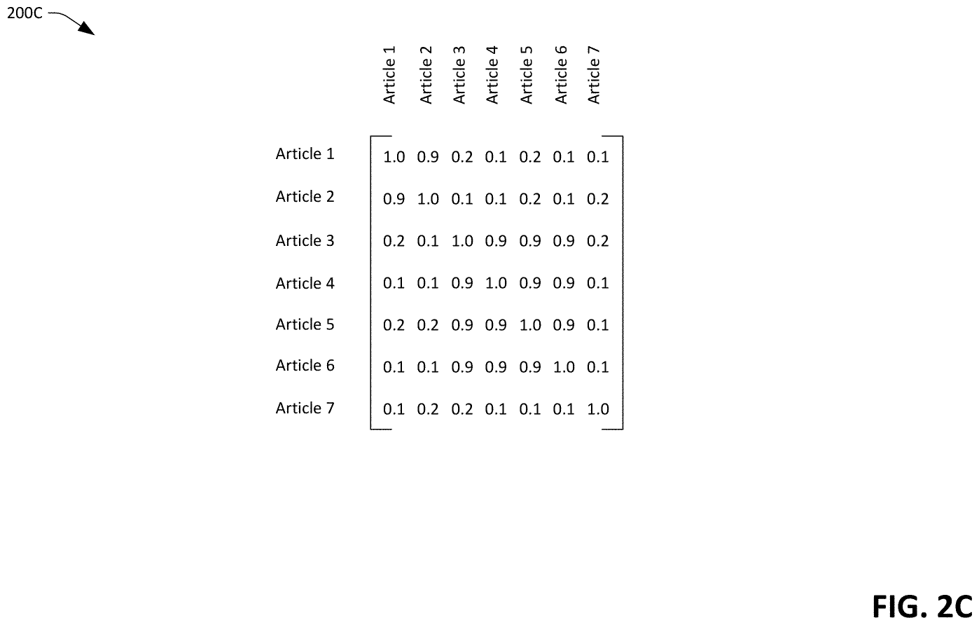

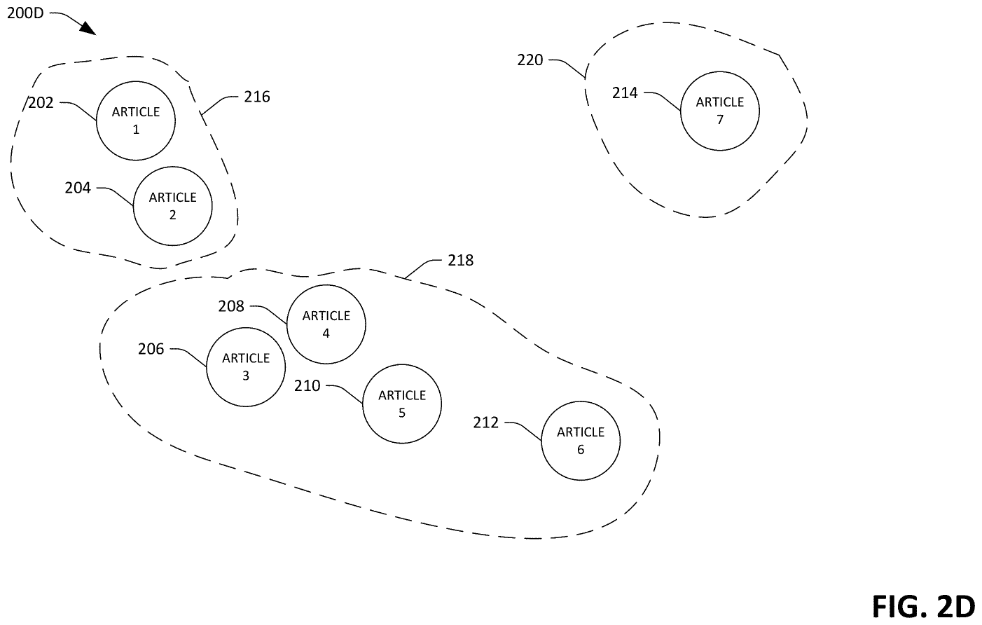

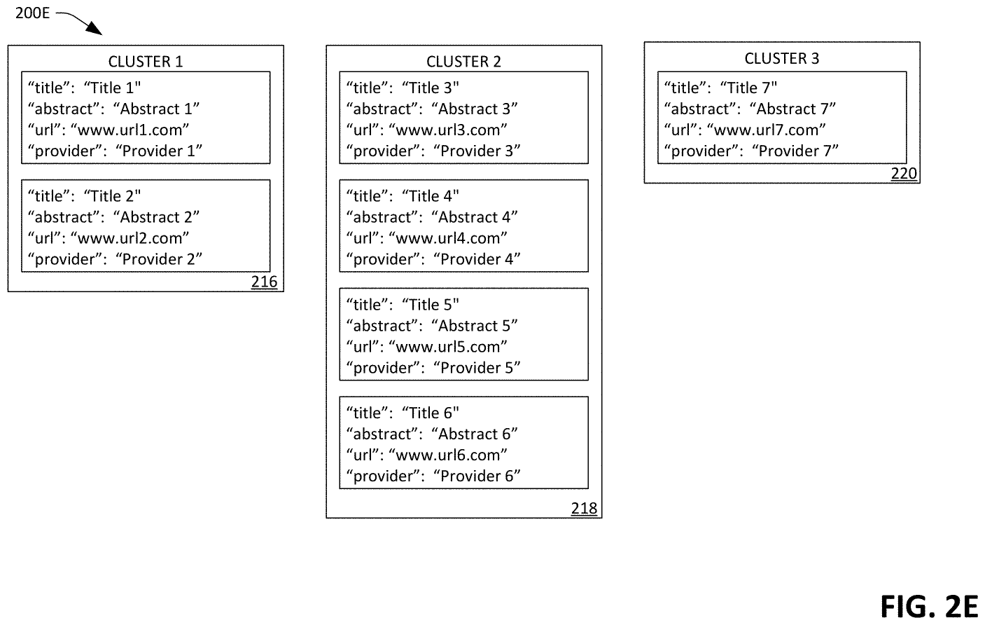

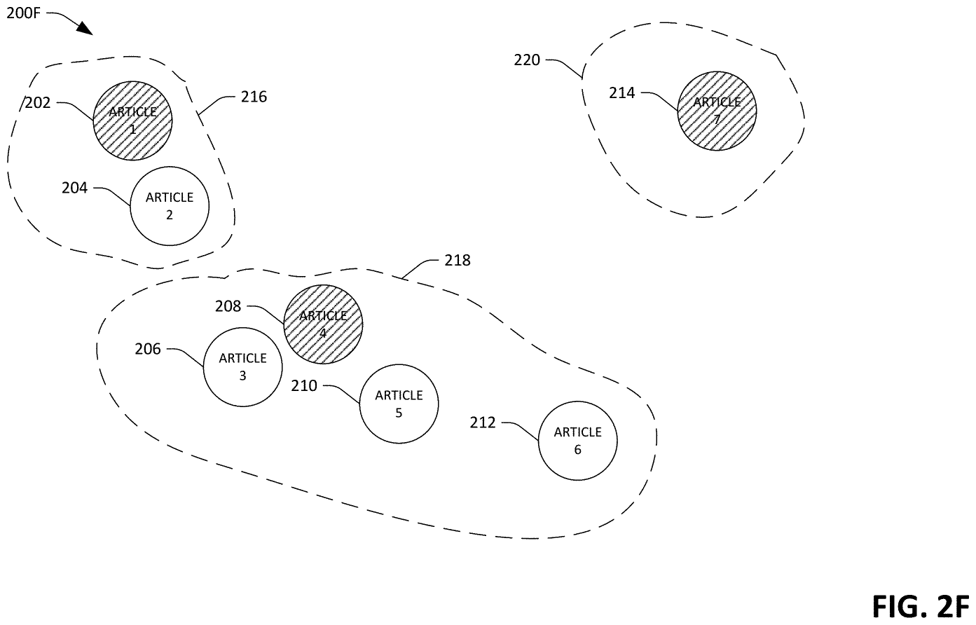

Operation of the computing system 100 is now set forth. According to embodiments, the retriever component 112 of the aggregator 110 obtains titles, abstracts, and URLs of the plurality of news articles 116 from the plurality of electronic sources 118. The retriever component 112 may also obtain an identifier for a provider (e.g., an organization) that published each of the plurality of news articles 116. According to other embodiments, the retriever component 112 obtains the plurality of news articles 116 themselves from the plurality of electronic sources 118. Referring briefly now to FIG. 2A, a symbolic representation 200A of a plurality of news articles is illustrated. The symbolic representation 200A includes a first news article 202, a second news article 204, a third news article 206, a fourth news article 208, a fifth news article 210, a sixth news article 212, and a seventh news article 214.

Referring back to FIG. 1, the encoder component 120 of the aggregator 110 generates an encoded, vectorized representation of each of the plurality of news articles 116 based upon content of each of the plurality of news articles 116. According to some embodiments, the encoder component 120 generates the encoded, vectorized representation of each of the plurality of news articles 116 based upon the titles and the abstracts of each of the plurality of news articles 116. According to other embodiments, the encoder component 120 generates encoded, vectorized representation of each of the plurality of news articles 116 based upon the non-abstract, non-title content of each of the plurality of news articles 116. The encoder component 120 may perform suitable pre-processing on each of the plurality of news articles 116 prior to encoding, such as tokenization, case-changing, punctuation changes, etc. According to embodiments, the encoded, vectorized representation of a news articles in the plurality of news articles 116 is an n-dimensional vector (that is, a vector having n entries), where n is a positive integer. In an example, n ranges from 100 to 1000. Referring briefly now to FIG. 2B, example encoded, vectorized representations 200B of the news articles 202-214 are depicted, with omitted entries from the encoded, vectorized representation 200B being indicated by ellipses. It is to be understood that values shown in FIG. 2B are for illustrative purposes only.

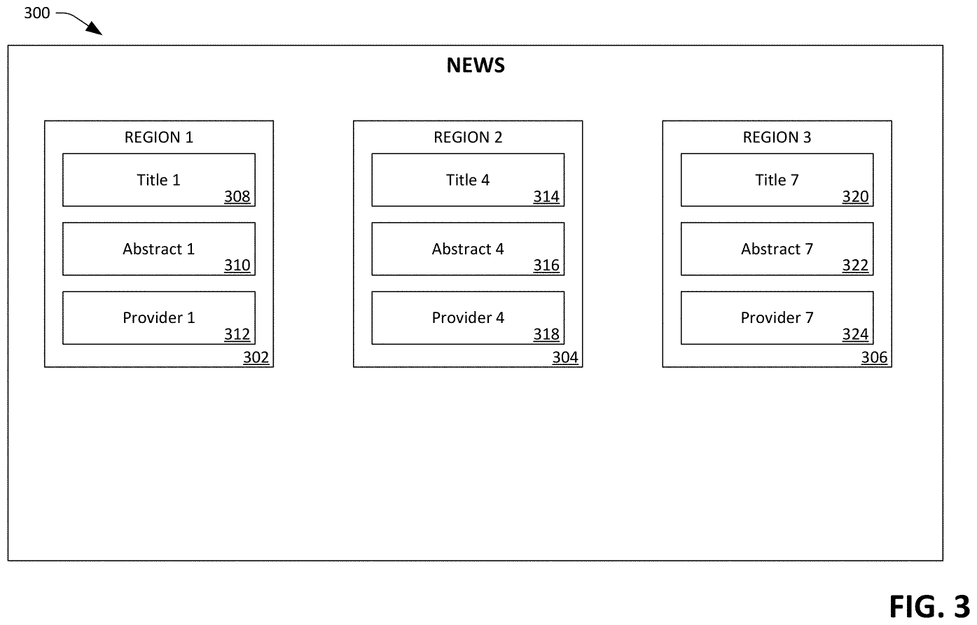

Referring back to FIG. 1, the similarity component 122 of the aggregator 110 computes a similarity metric between each of the plurality of news articles 116 based upon the encoded, vectorized representation of each of the plurality of news articles 116, thereby computing a plurality of similarity metrics. A similarity metric between a first news article and a second news article is indicative of how similar the first news article and the second news article are to one another. In an example, when the similarity metric is relatively high, the first news article and the second news article are similar to one another and when the similarity metric is relatively low, the first news article and second news article are dissimilar to one another. According to embodiments, the similarity metric is cosine similarity. According to embodiments, the similarity component 122 organizes each of the plurality of similarity metrics into a matrix, where each news article in the plurality of news articles 116 is assigned a row and a column within the matrix. Referring briefly now to FIG. 3C, an example matrix 200C is depicted. As depicted in FIG. 3C, the matrix 200C includes the plurality of similarity metrics, where the plurality of similarity metrics are organized according to rows and columns. In an example, a similarity metric located at the first row and the first column of the matrix 200C is “1.0”, as the first news article 202 is by definition identical to itself. In another example, a similarity metric located at the first row and the second column of the matrix 200C is “0.9”, indicating that the first news article 202 and the second news article 204 are relatively similar. In yet another example, a similarity metric located at the first row and the fourth column of the matrix 200C is “0.1”, indicating that the first news article 202 and the fourth news article 208 are relatively dissimilar. It is to be understood that values shown in FIG. 2C are for illustrative purposes only.

Referring back to FIG. 1, the cluster component 124 of the aggregator 110 clusters each of the plurality of news articles 116 into a plurality of clusters based upon the plurality of similarity metrics computed by the similarity component 122, where each cluster in the plurality of clusters is assigned to a different topic. As such, news articles belonging to a cluster each relate to the same topic. Stated differently, news articles belonging to the clusters are duplicative to one another. According to embodiments, the cluster component 124 clusters according to a density-based clustering model. According to embodiments, a number of clusters is not predetermined, that is, the cluster component 124 determines the number of dynamically based upon the plurality of similarity metrics. Referring briefly now to FIG. 2D, a symbolic representation 200D of clustering is depicted. As illustrated in FIG. 2D, the cluster component 124 has clustered the first news article 202 and the second news article 204 into a first cluster 216. The cluster component 124 has clustered the third news article 206, the fourth news article 208, the fifth news article 210, and the sixth news article 212 into a second cluster 218. The cluster component 124 has identified the seventh news article 214 as an orphan 220. The seventh news article 214 may represent a news article on a unique topic.

Referring back to FIG. 1, the cluster component 124 may store the clustered news article data 126 in the data store 108 subsequent to clustering. According to alternative embodiments, the cluster component 124 stores the clustered news article data 126 in the memory 106. Referring briefly to FIG. 2E, an illustration of example clustered news article data 200E is depicted. The clustered news article data 200E may be or include the clustered news article data 126 or the clustered news article data 126 may be or include the clustered news article data 200E. As illustrated in FIG. 2E, for each news article in a cluster, the clustered news article data 200E includes a title of a news article, an abstract of the news article, a URL of the news article, and a provider that published the news article. According to embodiments, the clustered news article data 200E further includes metadata for the news article, such as length, date of publishing, viewing information, and so forth.

Referring back to FIG. 1, the ranker component 128 of the aggregator 110 ranks each news article within each of the plurality of clusters based upon suitable ranking criteria (described above). The ranker component 128 selects a highest ranked article for each cluster based upon the ranks for presentment to the user 134. As each cluster represents a different topic, by selecting a highest ranked article within each cluster, the ranker component 128 ensures that users are not presented with identical news articles or news articles that pertain to the same topic. According to some embodiments, the ranker component 128 ranks the news articles within each cluster immediately subsequent to the clustering being performed by the cluster component 124. According to other embodiments, the ranker component 128 ranks the news articles within each cluster upon receiving a request for news from the news application 140. According to some embodiments, the ranker component 128 ranks the news articles within each cluster based upon user data of a user. Referring briefly now to FIG. 2F, a symbolic representation 200F of selecting news articles based upon ranks is illustrated. As illustrated in FIG. 2F, the ranker component 128 has selected the first news article 202 as being a representative news article of the first cluster 216 (and hence a first topic). The ranker component 128 has also selected the fourth news article 208 as being a representative news article of a second cluster 218 (and hence a second topic). As the seventh news article 214 has been identified as the orphan 220, the ranker component 128 has automatically selected the seventh news article 214.

Turning back to FIG. 1, it is contemplated that the news application 140 is to present information pertaining to news articles (from amongst the plurality of news articles 116) to the user 134. In an example, the client computing device 132 receives input from the user 134 which causes the news application 140 to be launched on the client computing device 132. In another example, the news application 140 is automatically launched on the client computing device 132 without receiving explicit input from the user 134.

The news application 140 transmits a request for news to the delivery component 130 of the aggregator 110. According to some embodiments, the request includes user data for the user 134, such as a preferred language of the user, user interests, etc. Upon receiving the request, the delivery component 130 obtains a title and an abstract for a representative news article (e.g., based upon the ranks assigned by the ranker component 128) for each cluster from the clustered news article data 126. The delivery component 130 may also obtain additional information for each representative news article, such as a thumbnail image or a preview video. According to embodiments where the request includes user data of the user 134, the delivery component 130 provides the user data to the ranker component 128 and the ranker component 128 ranks (or re-ranks) each of news articles within each cluster based upon the user data of the user 134.

According to embodiments, the delivery component 130 selects a threshold number of clusters (and hence topics) based upon suitable criteria, such as a number of news articles within each cluster, and presents a title and an abstract of a representative news article for each selected cluster on the display 146. In an example, a cluster that includes a large number of news articles is indicative of an important event and as such, the delivery component 130 selects clusters that include a threshold number of news articles and then selects representative news articles from each of the selected clusters to preserve screen space on the display 146 and avoid presenting the user 134 with an overwhelming number of news articles/topics.

The delivery component 130 transmits an abstract and a title (and optionally additional information) for a representative news article for each cluster (and hence each topic) to the news application 140. The news application 140 then presents the title and the abstract (and optionally the additional information) for the representative news article for each cluster (and hence each topic) in the news application GUI 148 shown on the display 146.

Turning now to FIG. 3, an example GUI 300 of the news application 140 is illustrated. The GUI 300 may be or include the news application GUI 148 or the news application GUI 148 may be or include the GUI 300. The GUI 300 includes a first region 302 assigned to the first cluster 216, a second region 304 assigned to the second cluster 218, and a third region 306 assigned to the orphan 220. In the example illustrated in FIG. 3, the first news article 202 has been selected as a representative news article of the first cluster 216 (and hence a first topic). As such, the first region 302 includes a first title 308 of the first news article 202, a first abstract 310 of the first news article 202, and a first identifier 312 of a first provider that published the first news article 202. The fourth news article 208 has been selected as a representative news article of the second cluster 218 (and hence a second topic). As such, the second region 304 includes a fourth title 314 of the fourth news article 208, a fourth abstract 316 of the fourth news article 208, and a fourth identifier 318 of a fourth provider that published the fourth news article 208. The seventh news article 214 has been identified as the orphan 220. As such, the third region 306 includes a seventh title 320 of the seventh news article 214, a seventh abstract 322 of the seventh news article 214, and a seventh identifier 324 of a seventh provider that published the seventh news article 214. The first region 302, the second region 304, and the third region 306 may also include additional information pertaining to their respective representative news articles, such as thumbnail images, preview videos, etc. (not illustrated in FIG. 3).

According to embodiments, some or all of the information displayed within each of the regions 302-306 is selectable. In an example, a URL for the first news article 202 is embedded within the first title 308 or the first abstract 310 of the first news article 202. When the GUI 300 receives a selection of the first title 308 or the first abstract 310, the news application 140 opens the URL and presents a full version of the first news article 202 on the display 146.

It is contemplated that the aggregator 110 performs the above-described processes (e.g., obtaining the plurality of news articles 116, generating the encoded, vectorized representations, clustering the plurality of news articles, and assigning ranks to the plurality of news articles, etc.) at predefined time intervals in order to provide the user 134 with currently relevant news. In an example, aggregator 110 performs the above-described processes every thirty minutes, every hour, or every day. It is further contemplated that the aggregator may purge some or all of the (previously generated) clustered news article data 126 from the data store 108 at the predefined intervals as well.

Although the aggregator 110 has been described above as aggregating and displaying news articles, other possibilities are contemplated. According to embodiments, the aggregator 110 performs the above-described processes on a collection of documents comprising computer-readable text. As such, it is to be understood that the aggregator 110 is not limited to aggregating and displaying news articles. Additionally, although the retriever component 112, the encoder component 120, the similarity component 122, the cluster component 124, the ranker component 128, and the delivery component 130 have been described above as executing on the server computing device 102, it is to be understood that some or all of these components may execute on different computing devices.

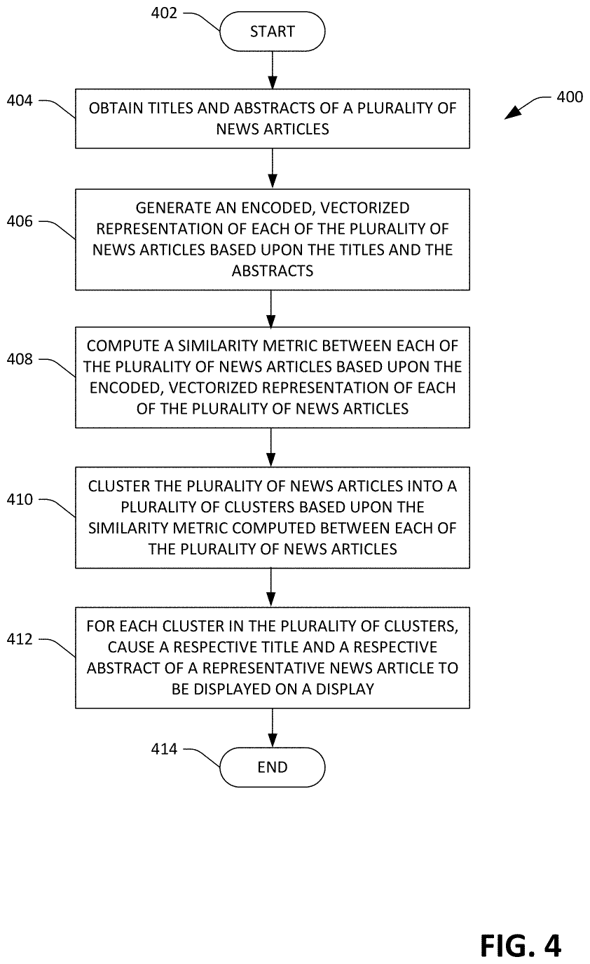

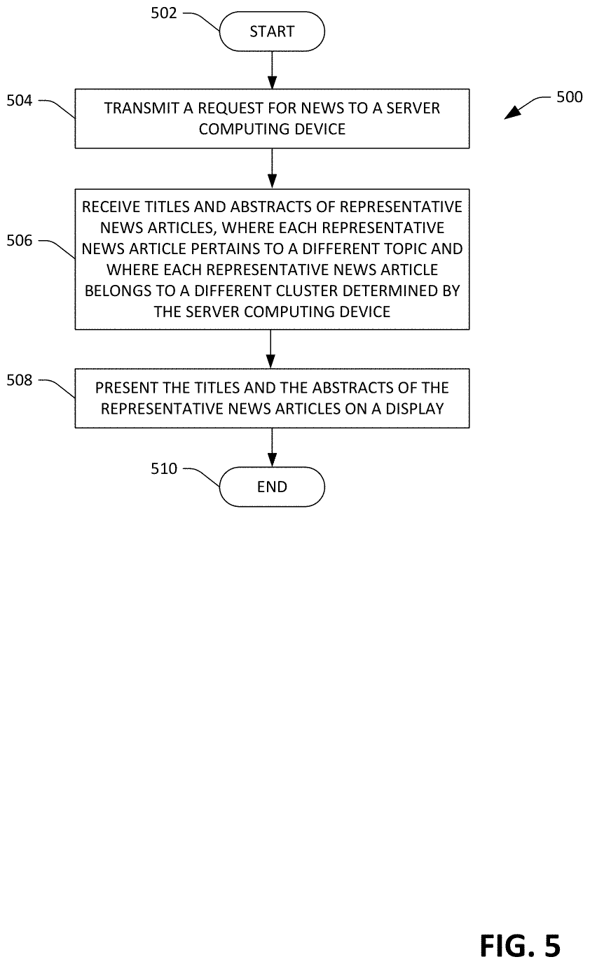

FIGS. 4 and 5 illustrate example methodologies relating to aggregating and curating news articles for display to users. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now to FIG. 4, a methodology 400 executed by a computing system that facilitates clustering and delivering news articles to computing devices for display is illustrated. The methodology 400 begins at 402, and at 404, the computing system obtains titles and abstracts of a plurality of news articles. At 406, the computing system generates an encoded, vectorized representation of each of the plurality of news articles based upon the titles and the abstracts. At 408, the computing system computes a similarity metric between each of the plurality of news articles based upon the encoded, vectorized representation of each of the plurality of news articles. At 410, the computing system clusters the plurality of news articles into a plurality of clusters based upon the similarity metric computed between each of the plurality of news articles, wherein each cluster in the plurality of clusters corresponds to a different topic. At 412, for each cluster in the plurality of clusters, the computing system causes a respective title and a respective abstract of a representative news article to be displayed on a display of a computing device. The methodology 400 concludes at 414.

Turning now to FIG. 5, a methodology 500 executed by a client computing device that facilitates displaying information pertaining to aggregated news articles is illustrated. The methodology 500 begins at 502, and at 504, the client computing device transmits a request for news to a server computing device. Prior to receiving the request from the client computing device, the server computing device selects a representative news article from each of a plurality of clusters, where each cluster corresponds to a different topic and where each cluster comprises one or more news article. Prior to receiving the request from the client computing device, the server computing device clusters a plurality of news articles into the plurality of clusters by generating an encoded, vectorized representation of each of the plurality of news articles based upon titles and abstracts of each of the plurality of news articles, computing a plurality of similarity metrics between each of the plurality of news articles based upon the encoded, vectorized representation of each of the plurality of news articles, and clustering the plurality of news articles into the plurality of clusters based upon the plurality of similarity metrics. At 506, the client computing device receives titles and abstracts of representative news articles from the server computing device. At 508, the client computing device presents the abstracts and the titles of the representative news articles on a display. The methodology 500 concludes at 510.

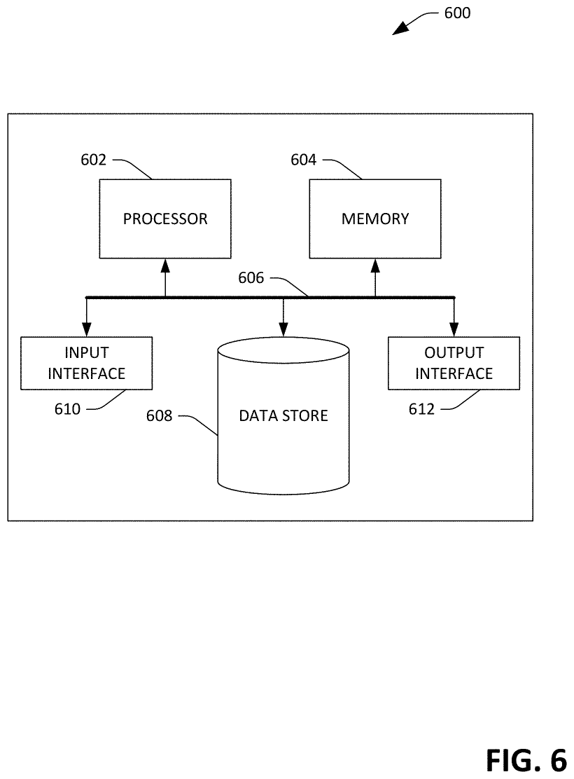

Referring now to FIG. 6, a high-level illustration of an example computing device 600 that can be used in accordance with the systems and methodologies disclosed herein is illustrated. For instance, the computing device 600 may be used in a system that aggregates news from a plurality of electronic sources. By way of another example, the computing device 600 can be used in a system that displays information from representative news articles for different topics on a display. The computing device 600 includes at least one processor 602 that executes instructions that are stored in a memory 604. The instructions may be, for instance, instructions for implementing functionality described as being carried out by one or more components discussed above or instructions for implementing one or more of the methods described above. The processor 602 may access the memory 604 by way of a system bus 606. In addition to storing executable instructions, the memory 604 may also store news articles, clustered news article data, computer-implemented models (e.g., encoding models, ranking models, clustering models), etc.

The computing device 600 additionally includes a data store 608 that is accessible by the processor 602 by way of the system bus 606. The data store 608 may include executable instructions, news articles, clustered news article data, computer-implemented models (e.g., encoding models, ranking models, clustering models), etc. The computing device 600 also includes an input interface 610 that allows external devices to communicate with the computing device 600. For instance, the input interface 610 may be used to receive instructions from an external computer device, from a user, etc. The computing device 600 also includes an output interface 612 that interfaces the computing device 600 with one or more external devices. For example, the computing device 600 may display text, images, etc. by way of the output interface 612.

It is contemplated that the external devices that communicate with the computing device 600 via the input interface 610 and the output interface 612 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 600 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 600 may be a distributed system. Thus, for instance, several devices may be in communication by way of a network connection and may collectively perform tasks described as being performed by the computing device 600.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. Such computer-readable storage media can include random-access memory (RAM), read-only memory (ROM), electrically erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The present disclosure relates to news aggregation according to at least the following examples provided in the section below:

(A1) In one aspect, some embodiments include a method (e.g., 400) executed by a processor (e.g., 104) of a computing system (e.g., 102). The method includes obtaining (e.g., 404) titles and abstracts of a plurality of news articles (e.g., 116). The method further includes generating (e.g., 406) an encoded, vectorized representation (e.g., 200B) of each of the plurality of news articles based upon the titles and the abstracts. The method additionally includes computing (e.g., 408) a similarity metric (e.g., 200C) between each of the plurality of news articles based upon the encoded, vectorized representation of each of the plurality of news articles. The method also includes clustering (e.g., 410) the plurality of news articles into a plurality of clusters (e.g., 216-218) based upon the similarity metric computed between each of the plurality of news articles, where each cluster in the plurality of clusters corresponds to a different topic. The method further includes for each cluster in the plurality of clusters, causing (e.g., 410) a respective title (e.g., 308, 314) and a respective abstract (e.g., 310, 316) of a representative news article to be displayed on a display (e.g., 146) of a computing device (e.g., 132).

(A2) In some embodiments of the method of A1, the method further includes subsequent to clustering the plurality of news articles and prior to causing the respective title and the respective abstract of the representative news article to be displayed, assigning ranks to each news article in each of the plurality of clusters based upon ranking criteria. The method additionally includes selecting the representative news article for each of the plurality of clusters based upon the ranks.

(A3) In some embodiments of any of the methods of A1-A2, the plurality of clusters include a first cluster (e.g., 216) and a second cluster (e.g. 218), wherein the first cluster includes a first news article (e.g., 202) and a second news article (e.g., 204) that each pertain to a first topic, wherein the second cluster includes a third news article (e.g., 206) that pertains to a second topic.

(A4) In some embodiments of any of the methods of A1-A3, the computing device is a gaming console and the respective title and the respective abstract of the representative news article are presented within a landing page of the gaming console shown on the display.

(A5) In some embodiments of any of the methods of A1-A4, causing the respective title and the respective abstract of the representative news article to be displayed on the display of the computing device occurs upon the computing system receiving a request from the computing device.

(A6) In some embodiments of any of the methods of A1-A5, the encoded, vectorized representation of each of the plurality of news articles is generated by way of a transformer-based encoder (e.g., 120).

(B1) In another aspect, some embodiments include a computing system (e.g., 102) that includes a processor (e.g., 104) and memory (e.g., 106). The memory stores instructions that, when executed by the processor, cause the processor to perform any of the methods described herein (e.g., any of A1-A6).

(C1) In yet another aspect, some embodiments include a non-transitory computer-readable storage medium that includes instructions that, when executed by a processor (e.g., 104), cause the processor to perform any of the methods described herein (e.g., any of A1-A6).

(D1) In another aspect, some embodiments include a method executed by a computing system (e.g., 102) that includes a processor (e.g., 104) and memory (e.g., 106). The method includes obtaining titles and abstracts of a plurality of news articles (e.g., 116). The method further includes generating an encoded, vectorized representation (e.g., 200B) of each of the plurality of news articles based upon the titles and the abstracts. The method additionally includes computing a similarity metric (e.g., 200C) between each of the plurality of news articles based upon the encoded, vectorized representation of each of the plurality of news articles. The method also includes clustering the plurality of news articles into a plurality of clusters (e.g., 216-218) based upon the similarity metric computed between each of the plurality of news articles, where each cluster in the plurality of clusters corresponds to a different topic. The method further includes for each cluster in the plurality of clusters, identifying a representative news article to be displayed for the cluster.

(D2) In some embodiments of the method of D1, the similarity metric computed between each of the plurality of news articles is cosine similarity.

(D3) In some embodiments of any of the methods of D1-D2, the clusters are generated by way of a density-based clustering model.

(D4) In some embodiments of any of the methods of D1-D3, the computing system identifies an orphan news article (e.g., 214) in the plurality of news articles, wherein the orphan news article is displayed along with the representative news article for each cluster.

(D5) In some embodiments of any of the methods of D1-D4, the encoded, vectorized representation of each of the plurality of news articles is an n-dimensional vector, where n is a positive integer, and the encoded, vectorized representation of each of the plurality of news articles comprises a plurality of values.

(D6) In some embodiments of any of the methods of D1-D5, the plurality of news articles include a first news article (e.g., 202) and a second news article (e.g., 204), wherein a first similarity metric is computed that is indicative of whether the first news article and the second news article pertain to a same topic.

(D7) In some embodiments of any of the methods of D1-D6, the method further includes receiving a request from a computing device (e.g., 132) of a user (e.g., 134) for news. The method additionally includes in response to receiving the request, returning the representative news article for at least one cluster to the computing device for presentment on a display (e.g., 146).

(D8) In some embodiments of any of the methods of D1-D7, the similarity metric computed between each of the plurality of news articles is organized into a matrix comprising rows and columns and a news article in the plurality of news articles is assigned a row and a column within the matrix.

(D9) In some embodiments of any of the methods of D1-D8, a first title (e.g., 308) of a first representative news article (e.g., 202) that pertains to a first topic is displayed in a first region (e.g., 302) of a display (e.g., 146) and a second title (e.g., 314) of a second representative news article (e.g., 208) that pertains to a second topic is displayed in a second region (e.g., 304) of the display.

(D10) In some embodiments of any of the methods of D1-D9, a quantity of the plurality of clusters is determined based upon the similarity metric computed between each of the plurality of news articles.

(D11) In some embodiments of any of the methods of D1-D10, the similarity metric computed between each of the plurality of news articles is indicative of semantic similarity between each of the plurality of news articles.

(E1) In another aspect, some embodiments include a computing system (e.g., 102) including a processor (e.g., 104) and memory (e.g., 106). The memory stores instructions that, when executed by the processor, cause the processor to perform any of the methods described herein (e.g., any of D1-D11).

(F1) In yet another aspect, some embodiments include a non-transitory computer-readable storage medium that includes instructions that, when executed by a processor (e.g., 104), cause the processor to perform any of the methods described herein (e.g., any of D1-D11).

(G1) In another aspect, some embodiments include a method performed by a computing system (e.g., 102) that includes a processor (e.g., 104). The method includes obtaining titles and abstracts of a plurality of news articles (e.g., 116). The method further includes generating an encoded, vectorized representation (e.g., 200B) of each of the plurality of news articles based upon the titles and the abstracts. The method additionally includes computing a similarity metric (e.g., 200C) between each of the plurality of news articles based upon the encoded, vectorized representation of each of the plurality of news articles. The method also includes clustering the plurality of news articles into a plurality of clusters (e.g., 216-218) based upon the similarity metric computed between each of the plurality of news articles, where each cluster in the plurality of clusters corresponds to a different topic. The method further includes for each cluster in the plurality of clusters, transmitting a respective title and a respective abstract of a representative news article to a computing device (e.g., 132), wherein the respective title and the respective abstract are displayed on a display (e.g., 146) of the computing device.

(G2) In some embodiments of the method of G1, the method further includes subsequent to clustering the plurality of news articles and prior to transmitting the respective title and the respective abstract of the representative news article to the computing device, storing clustered news article data (e.g., 126) in a computer-readable data store (e.g., 108), where the clustered news article data includes the respective title and the respective abstract of the representative news article, a uniform resource locator (URL) of the representative news article, and an identifier for a publisher of the representative news article.

(G3) In some embodiments of any of the method of G1-G2, the representative news article is selected based upon user data of a user (e.g., 134) that operates the computing device.

(H1) In another aspect, some embodiments include a computing system (e.g., 102) including a processor (e.g., 104) and memory (e.g., 106). The memory stores instructions that, when executed by the processor, cause the processor to perform any of the methods described herein (e.g., any of G1-G3).

(I1) In yet another aspect, some embodiments include a non-transitory computer-readable storage medium that includes instructions that, when executed by a processor (e.g., 104) of a computing system (e.g., 102), cause the processor to perform any of the methods described herein (e.g., any of G1-G3).

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system, comprising:
a processor; and
memory storing instructions that, when executed by the processor, cause the processor to perform acts comprising:
obtaining titles and abstracts of a plurality of news articles;
generating an encoded, vectorized representation of each of the plurality of news articles based upon the titles and the abstracts;
computing a similarity metric between each of the plurality of news articles based upon the encoded, vectorized representation of each of the plurality of news articles;
clustering the plurality of news articles into a plurality of clusters based upon the similarity metric computed between each of the plurality of news articles, wherein each cluster in the plurality of clusters corresponds to a different topic; and
for each cluster in the plurality of clusters, identifying a representative news article to be displayed for the cluster.

2. The computing system of claim 1, wherein the similarity metric computed between each of the plurality of news articles is cosine similarity.

3. The computing system of claim 1, wherein the clusters are generated by way of a density-based clustering model.

4. The computing system of claim 1, wherein the computing system identifies an orphan news article in the plurality of news articles, wherein the orphan news article is displayed along with the representative news article for each cluster.

5. The computing system of claim 1, wherein the encoded, vectorized representation of each of the plurality of news articles is an n-dimensional vector, where n is a positive integer, wherein the encoded, vectorized representation of each of the plurality of news articles comprises a plurality of values.

6. The computing system of claim 1, wherein the plurality of news articles include a first news article and a second news article, wherein a first similarity metric is computed that is indicative of whether the first news article and the second news article pertain to a same topic.

7. The computing system of claim 1, the acts further comprising:
receiving a request from a computing device of a user for news; and
in response to receiving the request, returning the representative news article for at least one cluster to the computing device for presentment on a display.

8. The computing system of claim 1, wherein the similarity metric computed between each of the plurality of news articles is organized into a matrix comprising rows and columns, wherein a news article in the plurality of news articles is assigned a row and a column within the matrix.

9. The computing system of claim 1, wherein a first title of a first representative news article that pertains to a first topic is displayed in a first region of a display, and wherein a second title of a second representative news article that pertains to a second topic is displayed in a second region of the display.

10. The computing system of claim 1, wherein a quantity of the plurality of clusters is determined based upon the similarity metric computed between each of the plurality of news articles.

11. The computing system of claim 1, wherein the similarity metric computed between each of the plurality of news articles is indicative of semantic similarity between each of the plurality of news articles.

12. A method executed by a processor of a computing system, the method comprising:
obtaining titles and abstracts of a plurality of news articles;
generating an encoded, vectorized representation of each of the plurality of news articles based upon the titles and the abstracts;
computing a similarity metric between each of the plurality of news articles based upon the encoded, vectorized representation of each of the plurality of news articles;
clustering the plurality of news articles into a plurality of clusters based upon the similarity metric computed between each of the plurality of news articles, wherein each cluster in the plurality of clusters corresponds to a different topic; and
for each cluster in the plurality of clusters, causing a respective title and a respective abstract of a representative news article to be displayed on a display of a computing device.

13. The method of claim 12, further comprising:
subsequent to clustering the plurality of news articles and prior to causing the respective title and the respective abstract of the representative news article to be displayed, assigning ranks to each news article in each of the plurality of clusters based upon ranking criteria; and
selecting the representative news article for each of the plurality of clusters based upon the ranks.

14. The method of claim 12, wherein the plurality of clusters include a first cluster and a second cluster, wherein the first cluster includes a first news article and a second news article that each pertain to a first topic, wherein the second cluster includes a third news article that pertains to a second topic.

15. The method of claim 12, wherein the computing device is a gaming console, wherein the respective title and the respective abstract of the representative news article are presented within a landing page of the gaming console shown on the display.

16. The method of claim 12, wherein causing the respective title and the respective abstract of the representative news article to be displayed on the display of the computing device occurs upon the computing system receiving a request from the computing device.

17. The method of claim 12, wherein the encoded, vectorized representation of each of the plurality of news articles is generated by way of a transformer-based encoder.

18. A non-transitory computer-readable storage medium comprising instructions that, when executed by a processor, cause the processor to perform acts comprising:
obtaining titles and abstracts of a plurality of news articles;
generating an encoded, vectorized representation of each of the plurality of news articles based upon the titles and the abstracts;
computing a similarity metric between each of the plurality of news articles based upon the encoded, vectorized representation of each of the plurality of news articles;
clustering the plurality of news articles into a plurality of clusters based upon the similarity metric computed between each of the plurality of news articles, wherein each cluster in the plurality of clusters corresponds to a different topic; and
for each cluster in the plurality of clusters, transmitting a respective title and a respective abstract of a representative news article to a computing device, wherein the respective title and the respective abstract are displayed on a display of the computing device.

19. The non-transitory computer-readable storage medium of claim 18, the acts further comprising:
subsequent to clustering the plurality of news articles and prior to transmitting the respective title and the respective abstract of the representative news article to the computing device, storing clustered news article data in a computer-readable data store, wherein the clustered news article data includes the respective title and the respective abstract of the representative news article, a uniform resource locator (URL) of the representative news article, and an identifier for a publisher of the representative news article.

20. The non-transitory computer-readable storage medium of claim 18, wherein the representative news article is selected based upon user data of a user that operates the computing device.
